(19) United States
(12) Patent Application Publication
(10) Pub. No.: US 2005/0254248 A1
(43) Pub. Date: Nov. 17, 2005

(54) CANDLE LIGHT EMULATION

(76) Inventor: Gabor Lederer, Paterson, NJ (US)

Correspondence Address: ISRAEL NISSENBAUM, 1038-56TH ST, BROOKLYN, NY, 11219, US

(21) Appl. No.: 10/905,163

(22) Filed: Mar. 24, 2005

Related U.S. Application Data
(60) Provisional application No. 60/572,202, filed on May 17, 2004.

(51) Int. Cl. F21V 35/00

(52) U.S. Cl. 362/392

(57) ABSTRACT

An electronic candle which emulates the appearance of a flame candle comprising a housing containing at least two colored light sources such as color light emitting diodes (LED), with the LEDs being angularly arranged relative to each other. The candle further comprises a power source for illuminating the LEDs, and a random switching LED driving circuitry with a voltage level alternator circuitry enhancer adapted to provide differing voltage levels required to drive different colored LEDs. The angled LED light sources are contained within a conically shaped enclosure having a hemispherical apex cap and wherein the wall of enclosure progressively thins from base to the apex and the enclosure comprises a dark colored ring at the base thereof to simulate a wick appearance.

### BACKGROUND OF THE INVENTION

Candles with electric flames, which imitate or simulate the flickering, swirling light of fire, are widely used in various applications and settings such as on tables of restaurants, in catering halls, in theatres, and in numerous ceremonial (e.g., religious) settings of all types. Various patents, U.S. Pat. Nos. 5,863,108, 6,017,139 and 6,066,924, have issued to the present inventor, which relate to different aspects of electronic or electric emulation of flame candles. These, and most, if not all, candle emulation embodiments are however concerned only with superficial electric or electronic emulation of a candle flame or exterior candle body and not a fully realistic flame appearance.

### SUMMARY OF THE INVENTION

It is an object of the present invention to further enhance the realism of the entire electric or electronic candles by utilizing high intensity and varied color LED type of light sources or similarly operable conventional filament, fluorescent, etc., type of light emitting elements.

It is another object of the present invention to create a flame simulation by use of a randomly switching circuitry that turns on the light sources (e.g., LED) in a random sequence and at random time intervals, as described in the aforementioned U.S. Pat. No. 6,066,924 (the entire disclosure thereof being incorporated herein by reference thereto). The present invention includes different color light sources such as color LEDs which enhance emulation appearance but which require different voltages, as described in co-pending patent application Ser. No. 10/666731, publication no. US20040179355A1 (the entire disclosure thereof being incorporated herein by reference thereto), wherein in the present invention, the circuitry is enhanced with a voltage buster or regulator which increases the battery or rechargeable battery voltage to a color dependent desired level.

It is yet another object of the present invention to further enhance candle emulation operation with facilitated control, with a battery charger input, where the power source connecting jack is utilized as a switch element operable with the insertion and removal of a non-conductive insert, to turn the battery power on or off respectively.

These and other objects, features and advantages of the present invention will become more evident from the following discussion and drawing in which:

### SHORT DESCRIPTION OF THE DRAWING

FIG. 1 is a circuit diagram of the electronics of the candle of the present invention with multiple LED lighting sources;

FIG. 2 is a cutaway view of a lighting module of a simulated candle of the present invention; and

FIG. 3 is a view of the relative arrangement of the LEDs used in effecting the candle simulation.

### DETAILED DESCRIPTION OF THE INVENTION

Generally the present invention comprises an electric or electronic candle having enhanced realistic simulation of an actual flame candle by utilizing and comprising at least two high intensity and color light sources such as LEDs rather than the single white conventional filament type of light emitting sources. The flame simulation is further enhanced by use of a randomly switching circuitry that turns on the light sources, in a random sequence and at random time. An aspect in enhancing an atmosphere of candle simulation comprises the use of different color LEDs for different color enclosures to further the created candle simulation atmosphere. The LEDs in a single enclosure are of a single color, though different enclosures may contain different colored light sets.

Different color LEDs require different driving voltages with the circuitry being provided with a voltage buster or regulator which increases or decreases the battery or rechargeable battery voltage to a color selective desired level. As described in said co-pending application, examples of specific color LEDs include those available from Marktech Optoelectronics and specifically those designated COTCO LC503THR1-30Q (red); LC503PPG1-30Q (green); LC503PBL1-30Q (blue); LC503TYL1-30Q (yellow),- with different operational voltage requirements.

In a further embodiment of the present invention, wherein a battery charger is utilized as an input, and in order to further enhance candle emulation operation with facilitated control, the power source connecting receptacle of the candle device is utilized as a switch by means of the insertion of a non-conductive insert to turn the power on or off.

The present invention requires a minimum of two light sources such as LEDs, which are angled from each other, i.e., shifted horizontally and vertically whereby their focused beam are at an angle to each other (neither of the light sources need be either horizontal or vertical). The lights are angularly arranged between a vertical stacking to a side by side arrangement in a horizontal positioning. In a preferred embodiment, the light arrangement is enclosed in a conical shaped enclosure having a wall with increasing variable thickness preferably ranging from about 40 mil at the base to about 25 mil at the apex. The apex of the conical enclosure is hemispherical and the material of the enclosure and apex are made of a material which is highly light transmitant or translucent. The conical shape of the enclosure, the hemispherical shape of the apex and the varying wall thickness provide an enhanced candle emulating light diffusion. Examples of suitable materials for the enclosure and apex cap include natural (not colored) ABS plastic or polycarbonate with an internally etched surface.

When the LEDs (or similar light source) are activated, the surface of this conical enclosure becomes highly illuminated with a variable on-off sequence of the two LED light sources. A swirling flame effect of a candle is created thereby.

In a preferred enhanced embodiment, a darker color ring insert is positioned at the base of the enclosure. This creates the effect and appearance of a wick thereby further enhancing the realistic appearance of the candle flame.

### DETAILED DESCRIPTION OF THE DRAWINGS

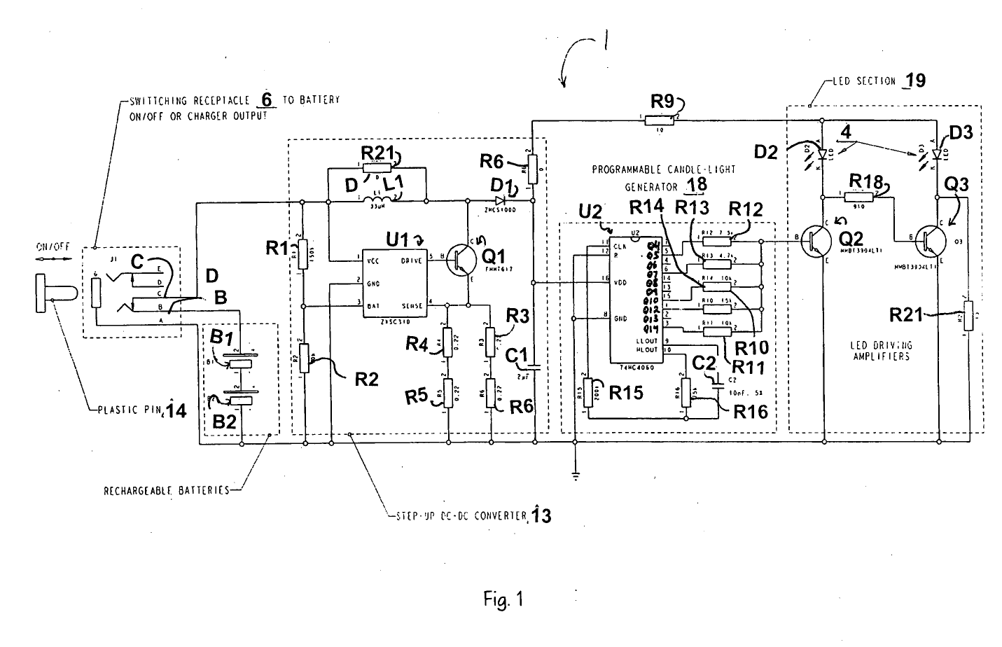

With reference to the drawings, in the circuit diagram 1 of FIG. 1, the electronics for the candle comprise switching receptacle 6 with an on/off or charger output. The power source for the candle is shown as two series connected rechargeable batteries B1 and B2, which provide the DC power to a step up DC to DC converter 13 and its components of transistor Q1, inductor L1, diode D1, and resistors R1,2,3,4,5,6,8,21. Circuit element U1 provides the color generation voltage changes with different color light components such as the colored LEDs described above. Non-conductive plastic pin 14, in the shape of the standard mono or stereo audio plug, is plugged into jack 6, with the spring biased connection between circuit contacts B and C being broken whereby power to the circuitry is blocked and the candle is turned off. Charger plug (not shown) is a typical stereo audio plug and it provides a connection between the batteries (B1, B2) and a charger (not shown). However, the charger plug, like plastic pin 14, blocks contact between contact elements B and C and candle 100 remains inactivated. However, the charger plug connects the batteries to the charger through element C and D. As a result, the batteries are charged without lighting of candle 100.

If neither pin 14 nor charger plug are in the receptacle, the circuitry is automatically connected to the battery by biased contact shorting of contact B with contact C.

Any rechargeable type of battery may be utilized to power the candle, provided that the shape and size are in conformity with the specified volume. In a preferred embodiment, the batteries are two series connected 1.2V 2/3 AA size 650 mA/h Ni-Cad batteries.

In the DC-DC converter 13, the U1 voltage converter Ic is set up as per factory recommendations. The transistor Q1 is the switching transistor of the converter and the inductor L1 and diode D1 provide the power for the programmable generator 18, and LED and LED driving section 19. The resistor R21 is used only if the current converter is not used. Programmable candle light generator 18 provides the random candle light emulation to drive the LED driving amplifier 19. C1 is a filter capacitor for element U2, which is a 14-stage ripple counter IC. The resistors R15, 16 and C2 oscillator give pulses for the counter where the pulses (in a binary sequence) come out on the U2 output 4 to 14 where the outputs are combined as a sequence depending on what type of random light “on-off” selection is desired. The common output drives the LED driving Q2 transistor with the selected resistor (R10, 11, 12, 13, 14) combination defining voltage pattern and wherein the Q2 transistor drives the Q3 transistor in the opposite phase through the resistor R18.

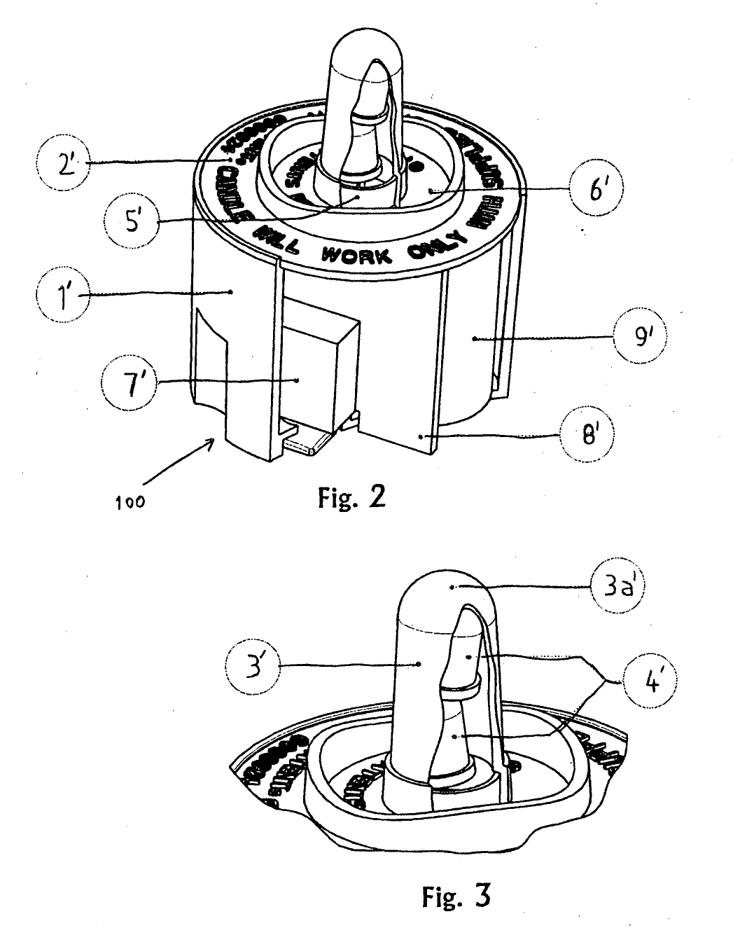

The candle in FIG. 2 comprises a candle housing 1, in which the PC board 8, with the circuitry of FIG. 1, is mounted. Batteries 9 (right side shown) are contained within candle housing 1. Charging-switching receptacle 7 contains contact elements (A to E). The illuminating LEDs 4 are shown at an offset angle relative to each other in FIGS. 2 and 3 and are contained within flame emulation conical enclosure 3 in FIGS. 2 and 3 and hemispherical cap 3a. The flame emulation conical enclosure 3 is a translucent body, set in candle top holder 2, through which the LED light is transmitted and embodies a black ring 5 to further enhance the flame emulation appearance as a wick simulation. Trough area 6 surrounded by a wall with an undulating height provides a dish for placement of an evaporating fragrant oil to simulate scented candles.

It is understood that the above description and drawings are exemplary of the present invention and that changes in structure, components, circuitry and the like may be made without departing from the scope of the present invention as defined in the following claims.

1. An electronic candle, which emulates the appearance of a flame candle, comprising a housing containing at least two colored light sources of like color, wherein different colored light sources require different driving voltages, with the light sources being arranged relative to each other at an angle ranging from vertical stacking to a side by side horizontal configuration with horizontally and vertically different planes whereby the directional angle beaming of the light sources are different and wherein the candle further comprises a power source for illuminating said light sources, and a random switching driving circuitry with a voltage level alternator circuitry enhancer adapted to provide appropriate voltage levels required to drive said different colored light sources.

2. The electronic candle of claim 1 wherein the light sources are light emitting diodes (LEDs).

3. The electronic candle of claim 2 wherein the angled LED light sources are contained within a conically shaped enclosure having a wall with a base and a hemispherical apex cap and wherein the thickness of the wall of enclosure progressively thins from base to the apex cap.

4. The electronic candle of claim 3 wherein said enclosure comprises a dark colored ring at the base thereof to simulate a wick appearance.

5. The electronic candle of claim 1, wherein the power source comprises a rechargeable battery element and a connecting jack for connection to a charger, and wherein the candle comprises switch means for activating the candle wherein said switch means is adapted to be activated with an inserted pin member.

6. The electronic candle of claim 1 wherein said candle comprises an exposed receptacle member for placement and retention of an evaporating fragrant oil therein to provide simulation of a scented candle.
